(19) United States
(12) Patent Application Publication
(10) Pub. No.: US 2020/0262970 A1
(43) Pub. Date: Aug. 20, 2020

(54) BIBENZOATE COPOLYESTERS

(71) Applicants: EXXONMOBIL CHEMICAL PATENTS INC., Baytown, TX (US); VIRGINIA TECH INTELLECTUAL PROPERTIES, INC., Blacksburg, VA (US)

(72) Inventors: Hans Eliot Edling, Blacksburg, VA (US); Haoyu Liu, Shanghai (CN); Ryan J. Mondshein, Blacksburg, VA (US); Timothy E. Long, Blacksburg, VA (US); S. Richard Turner, Blacksburg, VA (US); Ting Chen, Friendswood, TX (US)

(21) Appl. No.: 16/462,101

(22) PCT Filed: Oct. 18, 2017
(86) PCT No.: PCT/US2017/057259

§ 371 Date: May 17, 2019

Related U.S. Application Data
(60) Provisional application No. 62/425,872, filed on Nov. 23, 2016.

(51) Int. Cl. C08G 63/185; D01F 6/84; C08J 5/18

(52) U.S. Cl. CPC C08G 63/185; C08J 2367/03; C08J 5/18; D01F 6/84

(57) ABSTRACT

Copolyesters having improved properties based on a diacid component of 4,4′-biphenyl dicarboxylic acid or 3,4′-biphenyl dicarboxylic acid and a mixed diol component, such as 1,4 cyclohexanedimethanol (CHDM) with ethylene glycol or neopentyl glycol (NPG), e.g., poly(4,4′-biphenyl dicarboxylate-(ethylene glycol-co-CHDM)), poly(4,4′-biphenyl dicarboxylate-(NPG-co-CHDM)), poly(3,4′-biphenyl dicarboxylate-(ethylene glycol-co-CHDM)), poly(3,4′-biphenyl dicarboxylate-(NPG-co-CHDM)); methods of making the copolyesters; and shaped articles made of the copolyesters. Also, polyesters based on biphenyl dicarboxylic acid and NPG; methods of making the polyesters; and shaped articles made of the polyesters.

### CROSS REFERENCE TO RELATED APPLICATION

This application claims priority to and the benefit of provisional application U.S. 62/425,872 filed Nov. 23, 2016, which is incorporated by reference herein in its entirety.

### THE NAMES OF PARTIES TO A JOINT RESEARCH AGREEMENT

ExxonMobil Chemical Company, a division of ExxonMobil Corporation, and Virginia Polytechnic Institute and State University.

### BACKGROUND OF THE INVENTION

Amorphous copolyesters are important modern materials for numerous critical applications ranging from clear plastics for signs, transparent medical intravenous connectors, to transparent containers for food storage, and so on. The industry is ever in search of new polymers with a high glass transition temperature (T_{g}), as well as impact strength and other properties suitable for high performance applications.

High performance monomers such as 1,4-cyclohexanedimethanol (CHDM) and, to a more limited extent, 2,2′-dimethyl-1,3-propane diol (NPG), have been used in some polyesters, as in U.S. Pat. No. 5,773,554 and Turner, S. R. “Development of amorphous copolyesters based on 1,4-cyclohexanedimethanol,” J Polym. Sci.: Part A: Polym. Chem. 42, 5847-5852 (2004), to enhance toughness, resistance to hydrolytic degradation, and, in some cases, enhanced stability to weathering by UV. Poly(ethylene terephthalate) (PET) modified with less than 50 mol % of CHDM (or as polymerized, 1,4-cyclohexylenedimethylene) (PETG), and poly(1,4-cyclohexylenedimethylene terephthalate) (PCT) modified with less than 50 mol % ethylene glycol (PCTG), are examples of such polyesters.

Also, substitution of 4,4′-biphenyldicarboxylate (4,4′-BB) or 3,4′-biphenyldicarboxylate (3,4′-BB) for a portion of the terephthalate is known from U.S. Pat. No. 7,026,027 to enhance thermal properties, but can lead to difficult to process materials. Copolymers of 4,4′-biphenyl dicarboxylic acid (4,4′-BB) and terephthalic acid with a diol such as ethylene glycol are known from Krigbaum et al., Journal of Polymer Science, Polym. Letters, 20, 109, (1982); U.S. Pat. No. 4,082,731; and WO 2015/112252. The amorphous copolyesters of 4,4′-BB and terephthalate with ethylene glycol generally incorporate more terephthalate, and can have undesirably low glass transition temperatures and/or poor tensile properties such as toughness. When more 4,4′-BB is incorporated in an effort to elevate the glass transition temperature or improve other properties, the copolyester becomes semicrystalline.

The industry thus has a need for further enhancement of the Tg, elongation to break, and/or other properties, while maintaining or balancing melt processability.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

In any embodiment of the invention, a copolyester can comprise a diol component comprising a combination of first and second diols selected from the group consisting of C₂-C₂₀ alkylene diols and C₃-C₂₀ alicyclic polyhydroxyl compounds; and a diacid component comprising a diacid selected from 4,4′-biphenyl dicarboxylate and 3,4′-biphenyl dicarboxylate.

In any embodiment of the invention, a method comprises contacting (i) a diol component comprising a combination of first and second diols selected from the group consisting of C₂-C₂₀ alkylene diols and C₃-C₂₀ alicyclic polyhydroxyl compounds; with (ii) a diacid component comprising a diacid selected from 4,4′-biphenyl dicarboxylic acid, 3,4′-biphenyl dicarboxylic acid, or ester producing equivalents thereof, in the presence of (iii) a catalyst; and forming a copolyester comprising the diol component and the diacid component.

In any embodiment of the invention, a polyester may comprise a diol component comprising neopentyl glycol (NPG); and a biphenyl dicarboxylate, preferably selected from 4,4′-biphenyl dicarboxylate and 3,4′-biphenyl dicarboxylate.

### DETAILED DESCRIPTION OF THE PREFERRED EMBODIMENTS

Throughout the entire specification, including the claims, the following terms shall have the indicated meanings.

The term “and/or” refers to both the inclusive “and” case and the exclusive “or” case, and such term is used herein for brevity. For example, a composition comprising “A and/or B” may comprise A alone, B alone, or both A and B.

The percentages of monomers are expressed herein as mole percent (mol%) based on the total moles of monomers present in the reference polymer or polymer component. All other percentages are expressed as weight percent (wt%), based on the total weight of the particular composition present, unless otherwise noted. Room temperature is 25° C.±2° C. and atmospheric pressure is 101.325 kPa unless otherwise noted.

The term “consisting essentially of” in reference to a composition is understood to mean that the composition can include additional compounds other than those specified, in such amounts to the extent that they do not substantially interfere with the essential function of the composition, or if no essential function is indicated, in any amount up to 5% by weight of the composition.

For purposes herein, a “polymer” refers to a compound having two or more “mer” units (polyester mer units are esters derived from a diacid and a diol, as discussed below), that is, a degree of polymerization of two or more, where the mer units can be of the same or different species. A “homopolymer” is a polymer having mer units or residues that are the same species, e.g., a homopolyester has ester residues derived from a single diacid and a single diol. A “copolymer” is a polymer having two or more different species of mer units or residues, e.g., a copolyester has more than one species of ester residues derived from more than one diacid and/or more than one diol. A “terpolymer” is a polymer having three different species of mer units. “Different” in reference to mer unit species indicates that the mer units differ from each other by at least one atom or are different isomerically. Unless otherwise indicated, reference to a polymer herein includes a copolymer, a terpolymer, or any polymer comprising a plurality of the same or different species of repeating units.

The term “polyester”, as used herein, refers to a polymer comprised of residues derived from one or more polyfunctional acid moieties, collectively referred to herein as the “diacid component”, in ester linkage with residues derived from one or more polyhydroxyl compounds, which may also be referred to herein as “polyols” and collectively as the “diol component.” The term “repeating unit,” also referred to as the “mer” units, as used herein with reference to polyesters, refers to an organic structure having a diacid component residue and a diol component residue bonded through a carbonyloxy group, i.e., an ester linkage. Reference to the equivalent terms “copolyesters” or “(co)polyesters” or “polyester copolymers” herein is to be understood to mean a polymer prepared by the reaction of two or more different diacid compounds or ester producing equivalents thereof that incorporate different diacid residues into the backbone, and/or two or more different diol compounds that incorporate different diol residues into the backbone, i.e., either one or both of the diacid and diol components incorporate a combination of different species into the polymer backbone.

As used herein, the prefixes di- and tri- generally refer to two and three, respectively, with the exception of diacid and diol components noted herein. Similarly, the prefix “poly-” generally refers to two or more, and the prefix “multi-” to three or more. The carboxylic acids and/or esters used to make the copolyesters, or the residues of which are present therein, are collectively referred to herein as the “diacid component,” including both difunctional and multifunctional species thereof, or simply as the “acid component;” and likewise the hydroxyl compounds used to make the copolyesters, or the residues of which are present therein, are collectively referred to herein as the “diol component,” including both difunctional and multifunctional species thereof, or simply as the hydroxyl or polyol component.

The polycarboxylic acid residues, e.g., the dicarboxylate mer units, may be derived from a polyfunctional acid monomer or an ester producing equivalent thereof. Examples of ester producing equivalents of polyfunctional acids include one or more corresponding acid halide(s), ester(s), salts, the anhydride, or mixtures thereof. As used herein, therefore, the term “diacid” is intended to include polycarboxylic acids and any derivative of a polycarboxylic acid, including its associated acid halides, esters, half-esters, salts, half-salts, anhydrides, mixed anhydrides, or mixtures thereof, capable of forming esters useful in a reaction process with a diol to make polyesters.

As used herein, a “branching agent” is a multifunctional compound, e.g., a multifunctional carboxylic acid that causes or promotes the formation of branches in the growth of the polyester chain. A branching agent can be, for example, either a multifunctional hydroxyl component or a multifunctional acid component, or comprise a mixture of functionalities. Multifunctional hydroxyl branching agents can include, for example, triols such as glycerol, trimethylolpropane, ditrimethylol propane, trimethylolethane, pentaerythrytol, dipentaerythrytol, sorbitol, hexane triol-1,2,6 and so on. Multifunctional acid component branching agents can include, for example, trimellitic and/or pyromellitic anhydrides or acids, and the like, and their esters and ester producing equivalents thereof, and the like, in which the anhydride functional group(s) reacts to form two carboxylic acid or carboxylate groups. Furthermore, the term “branching agent” may include multifunctional compounds having a total number of mixed carboxylic acid and/or hydroxyl groups of three or more, e.g., two acid groups and one hydroxyl group, or one acid group and two hydroxyl groups, and the like.

The term “residue,” as used herein, means the organic structure of the monomer in its as-polymerized form as incorporated into a polymer, e.g., through a polycondensation and/or an esterification or transesterification reaction from the corresponding monomer. Throughout the specification and claims, reference to the monomer(s) in the polymer is understood to mean the corresponding as-polymerized form or residue of the respective monomer. For purposes herein, it is to be understood that by reference to a copolyester comprising a diacid component and a diol component, the diacid and diol components are present in the polymer in the as-polymerized (as-condensed) form. For example, the diacid component is present in the polymer as dicarboxylate in alternating ester linkage with the diol component, yet the polyester may be described as being comprised of, for example, the dicarboxylic acid or dicarboxylic acid alkyl ester and diol, where it is understood the alkyl ester groups in the starting material are not present in the polyester. For example, the diacid component is present in the polymer in alternating ester linkage with the diol component, yet the polyester may be described as being comprised of, for example, the dicarboxylic acid or dicarboxylic acid alkyl ester and diol, e.g., terephthalic acid-ethylene glycol polyester or dimethylterephthalate-ethylene glycol polyester, where it is understood the acid or methyl ester groups in the starting material are not present in the polyester.

Mole percentages of the diacid and diol components are expressed herein based on the total moles of the respective component, i.e., the copolyesters comprise 100 mol % of the polyfunctional acid component and 100 mol % of the polyfunctional hydroxyl component. For purposes herein, when a composition specifies a component, for example, a diacid component, having a particular mole percent of a first compound with the balance or remainder of another compound or mixture of compounds, it is to be understood that the balance refers to the amount of the second compound necessary to equal 100 mol % of that component, based on the total number of moles of all diacid compounds present, typically in polymerized form in the resultant copolyester. For example, a copolyester having a first diacid “A” from 30 to 60 mol % with the balance being the second diacid component “B” refers to a copolyester comprising 30 to 60 mol% diacid A and 70 to 40 mol % diacid B. In any embodiment where the diacid B may include at least one of a plurality of diacids B1 or B2, the 70 to 40 mol % of diacid B refers to any combination of diacids B1 and B2 necessary to equal the required 70 to 40 mol % of the total number of moles of all the diacid compounds present in polymerized form in the subject copolyester. Mole percentages of a branching agent are based on the total moles of repeating (ester-linked diacid-diol) units.

Unless otherwise indicated, for purposes herein an essentially amorphous polymer is defined as a polymer that does not exhibit a substantially crystalline melting point, Tm, i.e., no discernable heat of fusion or a heat of fusion less than 5 J/g, when determined by a heat/cool/reheat differential scanning calorimetry (DSC) analysis from the second heating ramp by heating of the sample from 0° C. to 300° C. at a heating and cooling rate of 10° C./min. The sample is held for 3 min between heating and cooling scans. For purposes herein, an amorphous polymer may alternatively be indicated if injection molding of the polymer produces an article which is essentially clear, wherein the injection molding process used is known to produce articles having cloudy or opaque character upon injection molding of a semi-crystalline polymer having similar properties to the amorphous polymer.

Conversely, a polymer exhibiting a crystalline melting point may be referred to herein as crystalline or, as is more common for polyesters, referred to herein as semicrystalline. A semicrystalline polymer often contains at least 5 wt % of a region or fraction having a crystalline morphology and at least 5 wt % of a region or fraction having an amorphous morphology. Semicrystalline polyesters often have up to 40 wt % crystallinity and 60 wt % or more of amorphous morphology.

For purposes herein, the melting temperature, crystallization temperature, glass transition temperature, etc., are determined by a heat/cool/reheat DSC analysis from the second heating ramp by heating of the sample from 0° C. to 300° C. at a heating and cooling rate of 10° C./min. The sample is held for 3 min between heating and cooling scans. The melting, crystallization, and glass transition temperatures are measured as the midpoint of the respective endotherm or exotherm in the second heating ramp.

Unless indicated otherwise, inherent viscosity is determined in 0.5% (g/dL) dichloroacetic acid solution at 25° C. by means of a CANNON TYPE B glass capillary viscometer, adapted from ASTM D4603. Inherent viscosity at 0.5 g/dL dichloroacetic acid solution was used to calculate intrinsic viscosity according to the method outlined by Schiraldi et al. (cf. Ma H, Hibbs M, Collard D M, Kumar S, and Schiraldi D A., Macromolecules, 2002; 35(13):5123-5130.). Inherent viscosity (ηᵢₙₕ) is calculated as the ratio of the natural logarithm of the relative viscosity to the mass concentration of the polymer according to the equation (A):

$${η}_{inh} = \frac{ ln {η}_{rel}}{c} \qquad ( A )$$

where c is the mass concentration of the polymer (g/dL) and ηᵣₑₗ is the relative viscosity, which is determined according to the equation (B):

$${η}_{rel} = \frac{η}{{η}_{0}} \qquad ( B )$$

where η is the viscosity of the solution and η₀ is the viscosity of the neat solvent. Unless otherwise specified, inherent viscosity is expressed as dL/g.

It is to be understood that for purposes herein, a polymer referred to as a “bibenzoate” comprises a diacid component comprising residues derived from a biphenyl dicarboxylic acid or ester producing equivalent thereof, such as, for example, 4,4′-biphenyl dicarboxylic acid or ester producing equivalent thereof as disclosed herein, 3,4′-biphenyl dicarboxylic acid or ester producing equivalent thereof as disclosed herein, or the combination thereof.

The difunctional hydroxyl compound can be a dihydric alcohol such as, for example, glycols and diols. The term “glycol” as used in this application includes, but is not limited to, diols, glycols, and/or multifunctional hydroxyl compounds. In any embodiment, the difunctional hydroxyl compound may be an alicyclic or aromatic nucleus bearing two hydroxyl substituents such as, for example, 2,2′,4,4′-tetramethyl-1,3-cyclobutanediol (TMCBD), 1,4-cyclohexanedimethanol (CHDM), as the cis or trans isomers, or a combination of cis and trans isomers, hydroquinone bis(betahydroxyethyl) ether, and/or the like.

For purposes herein, a polymer is “essentially free of crosslinking” if it contains no more than 5 wt % gel by weight of the polymer. In any embodiment herein, the polyester may be essentially free of crosslinking.

The following abbreviations are used herein: ASTM is ASTM International, formerly the American Society for Testing and Materials; 3,4′BB is 3,4′-biphenyl dicarboxylic acid or an ester producing analog such as dimethyl 3,4′-biphenyldicarboxylate; 4,4′BB is 4,4′-biphenyl dicarboxylic acid or an ester producing analog such as dimethyl 4,4′-biphenyldicarboxylate; BPA is bisphenol A; CHDM is 1,4-cyclohexanedimethanol; DCA is dichloroacetic acid; DEG is diethylene glycol; DMA is dynamic mechanical analysis; DMT is dimethyl terephthalate; T refers to terephthalic acid; DMI is dimethyl isophthalate; I refers to isophthalic acid; DSC is differential scanning calorimetry; EG is ethylene glycol; GPC is gel permeation chromatograph; HDT is heat distortion temperature; NPG is neopentyl glycol, 2,2-dimethyl-1,3-propanediol; PC is bisphenol A polycarbonate; PCT is poly(1,4-cyclohexylenedimethylene terephthalate); PCTG is PCT modified with less than 50 mol % ethylene glycol; PEN is polyethylene naphthalate; PET is polyethylene terephthalate; PETG is PET modified with less than 50 mol % of 1,4-cyclohexylenedimethylene; TFA is trifluoroacetic acid; TFA-d is deuterated trifluoroacetic acid; the letter “d” prior to a chemical name also indicates a deuterated compound; TGA is thermogravimetric analysis; CDCl₃ is deuterated chloroform; THF is tetrahydrofuran; TMA is trimellitic anhydride; and TMCBD is 2,2′,4,4′-tetramethyl-1,3-cyclobutanediol. For purposes herein, unless otherwise specified, reference to terephthalate and/or isophthalate is used interchangeably with terephthalic acid and isophthalic acid, respectively.

Polyesters according to any embodiment herein may be prepared from reaction of a diacid component and a diol component, which react in substantially equal molar proportions and are incorporated into the polyester polymer as their corresponding residues (i.e., in polymerized form). The polyesters useful in the present invention, therefore, can contain substantially equal molar proportions of acid residues and diol residues such that the total moles of repeating units of a diacid in which one of the two acid groups is esterified with one of the two hydroxyl groups of the diol are equal to 100 mol %. The mole percentages provided in the present invention, therefore, may be based on the total moles of acid residues, the total moles of diol residues, or the total moles of repeating units unless otherwise indicated.

In any embodiment of the present invention, a copolyester can comprise a diol component comprising a combination of first and second diols selected from the group consisting of C₂-C₂₀ alkylene diols and C₃-C₂₀ alicyclic polyhydroxyl compounds; and a diacid component comprising a diacid selected from 4,4′-biphenyl dicarboxylate (derived from 4,4′BB or ester producing equivalent thereof) and 3,4′-biphenyl dicarboxylate (derived from 3,4′-BB or ester producing equivalent thereof).

In any embodiment of the present invention, the diacid component can comprise, consist of, or consist essentially of, 4,4′-biphenyl dicarboxylate. If desired, a relatively minor amount of another diacid may be used that does not significantly affect the properties of the copolyester, e.g., up to 5 mol %, or up to 1 mol %, of the diacid component may comprise another diacid selected from 3,4′-biphenyl dicarboxylate, terephthalate, isophthalate, or a combination thereof (preferably terephthalate, isophthalate, or a combination thereof), based on the total moles of the diacid component in the copolyester, e.g., in an amount that does not substantially detract from the improvement in properties by using 4,4′-biphenyl dicarboxylate as the diacid component.

In any embodiment of the present invention, the diacid component can comprise, consist of, or consist essentially of 3,4′-biphenyl dicarboxylate. If desired, a relatively minor amount of another diacid may be used that does not significantly affect the properties of the copolyester, e.g., up to 5 mol %, or up to 1 mol %, of the diacid component may comprise another diacid selected from 4,4′-biphenyl dicarboxylate, terephthalate, isophthalate, or a combination thereof (preferably terephthalate, isophthalate, or a combination thereof), based on the total moles of the diacid component in the copolyester, e.g., in an amount that does not substantially detract from the improvement in properties by using 3,4′-biphenyl dicarboxylate as the diacid component.

In any embodiment of the present invention, the diol component can comprise, consist essentially of, or consist of the first and second diols selected from the group consisting of C₂-C₂₀ alkylene diols and C₃-C₂₀ alicyclic polyhydroxyl compounds, e.g., from about 10 to 90 mol % of the first diol and about 90 to 10 mol % of the second diol, based on the total moles of the diol component. In any embodiment, the first diol preferably comprises a lower limit selected from about 10, or 15, or 20, or 25, or 30, or 35, or 40, or 45, or 50, or 55, or 60, or 65, or 70, or 75, or 80, or 85, or 90 mol %, up to any higher limit of about 90, or 85, or 75, or 70, or 65, or 60, or 55, or 50, or 45, or 40, or 35, or 30, or 25, or 20 mol %, based on the total moles of the diol component, with the balance of the diol component being the second diol. If desired, a relatively minor amount of other diols may be used that does not significantly affect the properties of the copolyester, e.g., up to 5 mol %, or up to 1 mol %, of the diol component may comprise other diols, e.g., a C₂-C₂₀ alkylene diol or C₃-C₂₀ alicyclic polyhydroxyl compound other than the first and second diols, based on the total moles of the diol component in the copolyester, e.g., in an amount that does not substantially detract from the improvement in properties by using the first and second diol as the diol component.

In any embodiment of the present invention, the diol component preferably comprises from about 10 to 90 mol % of the first diol comprising CHDM and from about 90 to 10 mol % of the second diol selected from C₂ to C₂₀ alkylene diols, e.g., ethylene glycol, 1,3-propanediol, 1,4-butanediol, 1,6-hexanediol, NPG, or a combination thereof, based on the total moles of the diol component in the copolyester. For example, the diol component may comprise 20 mol % or more, or 30 mol % or more, or 40 mol % or more of CHDM, where the balance of the diacid component is ethylene glycol (or NPG), based on the total moles of the diacid component in the copolyester. If desired, the diol component may further comprise up to 5 mol %, or up to 2 mol %, or up to 1 mol %, of 1,3-propanediol, 1,4-butanediol, 1,6-hexanediol, NPG (or ethylene glycol), or a combination thereof, based on the total moles of the diol component in the copolyester, e.g., in an amount that does not substantially detract from the improvement in properties by using the first and second diol as the diol component.

In any embodiment of the present invention, the diol component preferably comprises from about 10 to 90 mol % of the first diol comprising NPG and from about 90 to 10 mol % of the second diol selected from another C₂ to C₂₀ alkylene diol or an alicyclic polyhydroxyl compound, e.g., ethylene glycol, 1,3-propanediol, 1,4-butanediol, 1,6-hexanediol, CHDM, or a combination thereof, based on the total moles of the diol component in the copolyester. For example, the diol component may comprise 20 mol % or more, or 30 mol % or more, or 40 mol % or more of NPG, where the balance of the diol component is ethylene glycol (or CHDM), based on the total moles of the diacid component in the copolyester. If desired, the diol component may further comprise up to 5 mol %, or up to 2 mol %, or up to 1 mol %, of 1,3-propanediol, 1,4-butanediol, 1,6-hexanediol, CHDM (or ethylene glycol), or a combination thereof, based on the total moles of the diol component in the copolyester, e.g., in an amount that does not substantially detract from the improvement in properties by using the first and second diol as the diol component.

For example, the diol component can comprise from about 10 to 90 mol % CHDM, and from about 90 to 10 mol % ethylene glycol (preferably from about 25 to 75 mol % CHDM, and from about 75 to 25 mol % ethylene glycol; or from about 30 to 70 mol % CHDM, and from about 70 to 30 mol % ethylene glycol; or from about 35 to 65 mol % CHDM, and from about 65 to 35 mol % ethylene glycol; or from about 40 to 60 mol % CHDM, and from about 60 to 40 mol % ethylene glycol), based on the total moles of the diol component in the copolyester. In this example, the diacid can consist essentially of 4,4′-biphenyl dicarboxylate or 3,4′-biphenyl dicarboxylate.

For another example, the diol component can comprise from about 10 to 90 mol % CHDM, and from about 90 to 10 mol % NPG (preferably from about 25 to 75 mol % CHDM, and from about 75 to 25 mol % NPG; or from about 30 to 70 mol % CHDM, and from about 70 to 30 mol % NPG; or from about 35 to 65 mol % CHDM, and from about 65 to 35 mol % NPG; or from about 40 to 60 mol % CHDM, and from about 60 to 40 mol % NPG), based on the total moles of the diol component in the copolyester. In this example, the diacid can consist essentially of 4,4′-biphenyl dicarboxylate or 3,4′-biphenyl dicarboxylate.

As a further example, the diol component can comprise from about 10 to 90 mol % NPG, and from about 90 to 10 mol % ethylene glycol (preferably from about 25 to 75 mol % NPG, and from about 75 to 25 mol % ethylene glycol; or from about 30 to 70 mol % NPG, and from about 70 to 30 mol % ethylene glycol; or from about 35 to 65 mol % NPG, and from about 65 to 35 mol % ethylene glycol; or from about 40 to 60 mol % NPG, and from about 60 to 40 mol% ethylene glycol), based on the total moles of the diol component in the copolyester. In this example, the diacid can consist essentially of 4,4′-biphenyl dicarboxylate or 3,4′-biphenyl dicarboxylate.

In any embodiment where the CHDM is present in the diol component, the CHDM can be present in the copolyester as a combination of cis isomers and trans isomers having a molar cis:trans ratio wherein the cis isomer is present at from 1 to 99 mol % with the balance being the trans isomer. In any embodiment, the cis isomer is preferably present at greater than or equal to about 10 mol %, or 20 mol %, or 30 mol %, or 40 mol %, or 50 mol %, or 60 mol %, or 70 mol %, or 80 mol %, with the balance being in the trans isomer, determined using ¹H NMR in d-trifluoroacetic acid/CDCl₃, based on the total moles of the CHDM component in the copolyester.

In any embodiment, the polymer may further comprise a branching agent as defined above, e.g., a multifunctional hydroxyl or carboxylic acid compound, preferably a multifunctional acid compound such as trimellitic or pyromellitic anhydride. Generally, the branching agent can be present in an amount effective to reduce the crystallinity and/or the rate of crystallization, and/or up to an amount that does not result in significant crosslinking, e.g., the copolyester can be essentially free of crosslinking or gel formation. In any embodiment, the copolymer can comprise an amount of trimellitic anhydride suitable to form a measurable amount of long chain branching in the copolymer, as determinable by DSC analysis at a heating rate of 10° C./min, ¹H NMR analysis, or ¹³C NMR analysis.

In any embodiment of the invention, the copolyester can comprise equal to or greater than about 0.001 mol % of the branching agent (e.g., a polycarboxylic acid moiety or ester producing derivative thereof), based on the total moles of repeating units in the copolyester. For example, the branching agent (e.g., trimellitic anhydride or glycerol) may be present at from about 0.001 to 1 mol %, or from about 0.005 to 0.5 mol %, or from about 0.01 to 0.5 mol %, or from about 0.02 to 0.3 mol %, or from about 0.05 to 0.3 mol %, or from about 0.1 to 0.3 mol %, based on the total moles of repeating units in the copolyester.

In any embodiment of the present invention, the copolyesters can comprise a number average molecular weight of equal to or greater than about 5,000 g/mol (or equal to or greater than 8,000, or equal to or greater than 10,000, or equal to or greater than 12,000, or equal to or greater than 15,000, or equal to or greater than 20,000, or equal to or greater than 30,000, or equal to or greater than 40,000, or equal to or greater than 50,000 g/mol); and/or a polydispersity of greater than 1.75 up to 3.5 (or from 1.8 up to 3, or from 1.8 to 2.5, or from 1.9 to 2.5, or about 2.0) where Mn and polydispersity are determined by GPC or calculated from the inherent viscosity. In the event of a conflict, the calculation from inherent viscosity shall control. In any embodiment of the invention, the polymer preferably exhibits an inherent viscosity equal to or greater than about 0.5 dL/g, or equal to or greater than about 0.7 dL/g, or equal to or greater than about 0.8 dL/g; and/or less than or equal to about 1 dL/g, or less than or equal to about 0.9 dL/g.

In any embodiment, the copolyesters preferably exhibit a glass transition temperature equal to or greater than about 90° C., or equal to or greater than about 95° C., or equal to or greater than about 100° C., or equal to or greater than about 105° C., or equal to or greater than about 110° C., or equal to or greater than about 112° C., or equal to or greater than about 114° C., or equal to or greater than about 115° C., or equal to or greater than about 116° C., or equal to or greater than about 118° C., or equal to or greater than about 120° C., or equal to or greater than about 125° C., or equal to or greater than about 130° C.

Often, the copolyesters can exhibit a zero shear melt viscosity of less than 1700 Pa·s, or less than 1500 Pa·s, or less than 1300 Pa·s, or less than 1100 Pa·s, determined according to ASTM D3835 at 275° C.

Often, the copolyesters can exhibit an essentially amorphous morphology, e.g., the polymer does not comprise a measurable crystallization temperature Tc and/or does not comprise a discernable melting temperature Tm.

Often, the copolyesters can exhibit a semicrystalline morphology. In any embodiment, the polymer preferably comprises relative amounts of 4,4′-biphenyl dicarboxylate, 3,4′-biphenyl dicarboxylate, terephthalate, and/or isophthalate sufficient to produce a melting point peak, a crystallization point peak, or both. When the copolyester is semi-crystalline, it preferably has a melting point of less than 270° C., or less than 260° C., or less than 250° C., or less than 240° C., or less than 235° C.

Often, the polyester copolymer can exhibit less than or equal to about 20 wt % crystallinity, or less than or equal to about 10 wt % crystallinity, or less than or equal to about 5 wt % crystallinity, or less than or equal to about 1 wt % crystallinity, determined by DSC analysis from a second heating ramp at a heating rate of 10° C./min.

It is expected that the copolyesters, according to the present invention, have an elongation to break greater than 100%, when determined according to ASTM D638; and/or a tensile stress at break of greater than 50 MPa, when determined according to ASTM D638; and/or a yield stress of greater than 45 MPa, when determined according to ASTM D638; and/or a Young's modulus greater than 1.7 GPa, when determined according to ASTM D638; and/or a semi-crystalline morphology preferably having a melting point of less than 260° C., or less than 250° C., or less than 240° C., or less than 235° C.; and/or an inherent viscosity of greater than 0.7 dL/g; and/or an essentially amorphous morphology, preferably having a glass transition temperature greater than 120° C., and preferably having a zero shear melt viscosity of less than 1700 Pa·s (or less than 1500 Pa·s, or less than 1300 Pa·s, or less than 1100 Pa·s), determined according to ASTM D3835 at 275° C.

Preferably, the Tm is less than the lowest Tm of the corresponding copolyesters made with a single diacid, preferably at least 20° C. less or at least 30° C. less than either of the corresponding single-diol copolyesters having a single diacid component.

Often, the copolyester can exhibit an elongation at break of equal to or greater than about 70%, or 80%, or 90%, or 100%, or 105%, or 110%, or 120%, or 130%, or 150%, determined according to ASTM D638.

Often, the copolyester can exhibit a tensile strength, also referred to as a tensile stress, of equal to or greater than about 45 MPa, or 50 MPa, or 55 MPa, or 60 MPa, determined according to ASTM D638.

Often, the copolyester can exhibit a yield stress of equal to or greater than about 30 MPa, or 35 MPa, or 40 MPa, or 45 MPa, determined according to ASTM D638.

Often, the copolyester can exhibit a Young's Modulus of equal to or greater than about 1.6 GPa, or 1.7 GPa, or 1.9 GPa, or 2.0 GPa, or 2.05 GPa, determined according to ASTM D638.

Often, the polyester copolymer can exhibit a thermal degradation temperature (Td) of equal to or greater than about 300° C., or equal to or greater than about 350° C., or equal to or greater than about 375° C., or equal to or greater than about 400° C., at 5 wt %, determined according to ASTM D3850 by thermogravimetric analysis.

Often, the polymer can exhibit a tensile modulus (without extensometer) of equal to or greater than about 1200 MPa, or equal to or greater than about 1300 MPa, or equal to or greater than about 1400 MPa, or equal to or greater than about 1500 MPa, determined according to ASTM D638.

Often, the polymer can exhibit a flexural strength of equal to or greater than about 65 MPa, or equal to or greater than about 70 MPa, or equal to or greater than about 75 MPa, determined according to ASTM D638.

Often, the polymer can exhibit a flexural modulus of equal to or greater than about 1500 MPa, or equal to or greater than about 1800 MPa, or equal to or greater than about 2000 MPa, or equal to or greater than about 2200 MPa, equal to or greater than about 2400 MPa, determined according to ASTM D638.

The heat distortion temperature (HDT) is the temperature at which a sample deforms under a specified load of 455 kPa or 1.82 MPa, determined according to ASTM D648. Often, the copolyester can comprise an HDT at 455 kPa of equal to or greater than about 65° C., or equal to or greater than about 70° C., or equal to or greater than about 75° C., or equal to or greater than about 80° C., or equal to or greater than about 90° C., or equal to or greater than about 100° C., or equal to or greater than about 105° C., determined according to ASTM D648. Often, the polyester copolymer can comprise an HDT at 1.82 MPa of equal to or greater than about 60° C., or equal to or greater than about 65° C., or equal to or greater than about 70° C., or equal to or greater than about 75° C., or equal to or greater than about 80° C., or equal to or greater than about 90° C., determined according to ASTM D648.

In any embodiment, the copolyester can exhibit a number average molecular weight of equal to or greater than about 5,000 g/mol and/or a glass transition temperature equal to or greater than about 90° C., and/or an elongation to break greater than 100%, when determined according to ASTM D638, and/or a tensile stress at break of greater than 50 MPa, when determined according to ASTM D638, and/or a yield stress of greater than 45 MPa, when determined according to ASTM D638, and/or a Young's modulus greater than 1.7 GPa, when determined according to ASTM D638.

Often, the copolyester can have a semi-crystalline morphology, preferably having a melting point of less than 280° C. For example, poly(4,4′-biphenylene dicarboxylate-ethylene glycol-co-CHDM) can have a semicrystalline morphology, preferably when the diol component comprises from about 40 to 60 mol % ethylene glycol and from about 60 to 40 mol % CHDM, based on the total moles of the diol component. Generally, as the proportion of CHDM is increased in this system, the glass transition temperature can increase while the melting temperature can decrease, e.g., above about 50 mol % CHDM and below about 50 mol % ethylene glycol, the glass transition temperature can be about 100° C. or more (e.g., 99°-103° C.) and the melting temperature can be below about 275° C. (e.g., about 272° C. or below), as seen in Examples 1-3 below.

Often, the copolyester can have an essentially amorphous morphology. For example, poly(4,4′-biphenylene dicarboxylate-NPG-co-CHDM) can have an essentially amorphous morphology, preferably when the diol component comprises from about 40 to 70 mol % NPG and from about 60 to 30 mol % CHDM (preferably from about 45 to 65 mol % NPG and from about 55 to 35 mol % CHDM, or from about 50 to 55 or 60 mol % NPG and from about 50 to 40 or 35 mol % CHDM), based on the total moles of the diol component. Generally, the glass transition temperature can be from about 120° C. possibly up to 135° C. or more (e.g., about 125°-130° C.), as seen in Examples 4-5 below.

As another example, poly(3,4′-biphenylene dicarboxylate-NPG-co-CHDM) can have an essentially amorphous morphology, preferably when the diol component comprises from about 40 to 60 mol % NPG and from about 60 to 40 mol % CHDM (preferably from about 45 to 55 mol % NPG and from about 55 to 45 mol % CHDM, or about 50 mol % NPG and about 50 mol % CHDM), based on the total moles of the diol component. Generally, the glass transition temperature can be from about 120° C., possibly up to 135° C. or more (e.g., about 125°-130° C.), as seen in Examples 6-7 below.

As a further example, poly(3,4′-biphenylene dicarboxylate-ethylene glycol-co-CHDM) can have an essentially amorphous morphology, preferably when the diol component comprises from about 40 to 65 mol % ethylene glycol and from about 60 to 35 mol % CHDM (preferably from about 45 to 60 mol % ethylene glycol and from about 55 to 40 mol % CHDM), based on the total moles of the diol component. Generally, as the proportion of CHDM is increased in this system, the glass transition temperature can increase, e.g., the glass transition temperature can be from about 105° C., possibly up to 115° C. or more (e.g., about 107° to 112° C.), as seen in Examples 8-9 below.

In any embodiment, a polyester may comprise a diol component comprising, or preferably consisting essentially of or consisting of neopentyl glycol (NPG), and a diacid component comprising a biphenyl dicarboxylate, preferably a diacid selected from 4,4′-biphenyl dicarboxylate and 3,4′-biphenyl dicarboxylate. Preferably the polyester has an amorphous morphology.

In any embodiment, the invention can provide a shaped article comprising any of the copolyester embodiments described above, e.g., in the form of a fiber, a nonwoven fabric, a film, or a molded article.

Generally, a method comprises contacting (i) a diol component comprising a combination of first and second diols selected from the group consisting of a C₂-C₂₀ alkylene diol, a C₂-C₂₀ alicyclic polyhydroxyl compound, and a combination thereof; with (ii) a diacid component comprising a diacid selected from 4,4′-biphenyl dicarboxylic acid (4,4′-BB), 3,4′-biphenyl dicarboxylic acid (3,4′-BB), and ester producing equivalents thereof, in the presence of (iii) a catalyst; and forming a copolyester comprising the diol and diacid components. Preferably, the diacid component can comprise, consist essentially of, or consist of 4,4′-BB (or ester producing equivalents thereof), or 3,4′-BB (or ester producing equivalents thereof). In any embodiment, the diacid component can further comprise up to 5 mol % of other diacids, based on the total moles of the diacid component in the copolyester, e.g., terephthalic acid, isophthalic acid, or an ester producing equivalent thereof, or the like, or a combination thereof.

Preferably, the diol component in the method comprises, consists essentially of, or consists of the first and second diols. In any embodiment, the diol component can further comprise up to 5 mol % of other diols, based on the total moles of the diol component in the copolyester.

In any embodiment of the method, the diol and acid components can be as described above for the copolyesters. For example, the diol component can comprise from about 10 to 90 mol % of the first diol comprising CHDM, and from about 90 to 10 mol % of the second diol selected from a C₂ to C₂₀ alkylene diol (preferably C₂ to C₈ alkylene diol), e.g., ethylene glycol, 1,3-propanediol, 1,4-butanediol, 1,6-hexanediol, NPG, or the like, or a combination thereof, or preferably ethylene glycol or NPG, based on the total moles of the diol component in the copolyester.

As another example, the diol component in the method can comprise from about 10 to 90 mol % of the first diol comprising NPG, and from about 90 to 10 mol % of the second diol selected from another C₂ to C₂₀ alkylene diol (preferably C₂ to C₈ alkylene diol) or an alicyclic polyhydroxyl compound, e.g., ethylene glycol, 1,3-propanediol, 1,4-butanediol, 1,6-hexanediol, CHDM, or the like, or a combination thereof, preferably ethylene glycol or CHDM, based on the total moles of the diol component in the copolyester.

As a further example, the diol component in the method can comprise from about 10 to 90 mol % CHDM, and from about 90 to 10 mol % ethylene glycol, NPG, or a combination thereof, based on the total moles of the diol component in the copolyester.

Preferably, the diol component in the method comprises from about 10 to 90 mol % CHDM, and from about 90 to 10 mol % ethylene glycol (preferably from about 25 to 75 mol % CHDM, and from about 75 to 25 mol % ethylene glycol; or from about 30 to 70 mol % CHDM, and from about 70 to 30 mol % ethylene glycol; or from about 35 to 65 mol % CHDM, and from about 65 to 35 mol % ethylene glycol; or from about 40 to 60 mol % CHDM, and from about 60 to 40 mol % ethylene glycol), based on the total moles of the diol component in the copolyester.

Preferably, the diol component in the method comprises from about 10 to 90 mol % CHDM, and from about 90 to 10 mol % NPG (preferably from about 25 to 75 mol % CHDM, and from about 75 to 25 mol % NPG; or from about 30 to 70 mol % CHDM, and from about 70 to 30 mol % NPG; or from about 35 to 65 mol % CHDM, and from about 65 to 35 mol % NPG; or from about 40 to 60 mol % CHDM, and from about 60 to 40 mol % NPG), based on the total moles of the diol component in the copolyester.

Preferably, the diol component in the method comprises from about 10 to 90 mol % NPG, and from about 90 to 10 mol % ethylene glycol (preferably from about 25 to 75 mol % NPG, and from about 75 to 25 mol % ethylene glycol; or from about 30 to 70 mol % NPG, and from about 70 to 30 mol % ethylene glycol; or from about 35 to 65 mol % NPG, and from about 65 to 35 mol % ethylene glycol; or from about 40 to 60 mol % NPG, and from about 60 to 40 mol% ethylene glycol), based on the total moles of the diol component in the copolyester.

In any embodiment, the method may comprise contacting (i) a diol component comprising, or preferably consisting essentially of or consisting of neopentyl glycol (NPG), with (ii) a diacid component comprising a biphenyl dicarboxylate, preferably a diacid selected from 4,4′-biphenyl dicarboxylate and 3,4′-biphenyl dicarboxylate, and forming a polyester comprising the diol and diacid components, preferably wherein the polyester has an amorphous morphology. The method may further comprise forming the polyester into a shaped article, and/or into a fiber, a nonwoven fabric, a film, or a molded article.

In any embodiment of the method, the polymer may further comprise less than or equal to 5 mol % of a branching agent, e.g., a multifunctional hydroxyl or carboxylic acid compound, preferably a multifunctional acid compound such as trimellitic or pyromellitic anhydride, and/or a multifunctional polyol compound such as glycerol, sorbitol, hexane triol-1,2,6, pentaerythritol, or trimethylolethane. Preferably, the branching agent is present in an amount effective to reduce the crystallinity and/or the rate of crystallization, and/or up to an amount that does not result in significant crosslinking, e.g., the copolyester can be essentially free of crosslinking or gel formation. Preferably, the copolymer comprises an amount of trimellitic anhydride suitable to form a measurable amount of long chain branching in the copolymer, as determinable by DSC analysis at a heating rate of 10° C./min, ¹H NMR analysis, or ¹³C NMR analysis.

In any embodiment of the method, the copolyester may comprise equal to or greater than about 0.001 mol % of the branching agent (e.g., a tricarboxylic acid moiety or ester producing derivative thereof, or a triol), based on the total moles of repeating units in the copolyester. For example, the branching agent (e.g., trimellitic anhydride or glycerol) may be present at from about 0.001 to 5 mol %, or from about 0.005 to 1 mol %, or from about 0.01 to 0.5 mol %, or from about 0.02 to 0.3 mol %, or from about 0.05 to 0.3 mol %, or from about 0.1 to 0.3 mol %, based on the total moles of repeating units in the copolyester. Preferably, the diacid component of the polymer consists essentially of 4,4′-biphenyl dicarboxylic acid combined with trimellitic anhydride, or 3,4′-biphenyl dicarboxylic acid, and trimellitic anhydride.

In any embodiment, the method can produce a polyester comprising a number average molecular weight of equal to or greater than about 5,000 g/mol.

In any embodiment, the method can produce a polyester comprising a glass transition temperature equal to or greater than about 90° C., or equal to or greater than about 95° C., or equal to or greater than about 100° C., or equal to or greater than about 105° C., or equal to or greater than about 110° C., or equal to or greater than about 115° C., or equal to or greater than about 120° C., or equal to or greater than about 125° C.

In any embodiment, the method can produce a polyester exhibiting a zero shear melt viscosity is less than 1700 Pa·s, or less than 1500 Pa·s, or less than 1300 Pa·s, or less than 1100 Pa·s, determined according to ASTM D3835 at 275° C.

Often, the method can produce a copolyester comprising an essentially amorphous morphology.

Often, the method can produce a copolyester comprising a semi-crystalline morphology, preferably having a melting point of less than about 280° C.

In any embodiment, the method can further comprise forming the copolyester into a shaped article. For example, the method can further comprise forming the copolyester or into a fiber, a nonwoven fabric, a film, or a molded article.

In any embodiment of the invention, the copolyesters may be prepared by melt polymerization techniques including transesterification and polycondensation, in batch, semi-batch or continuous processes. The copolyesters are preferably prepared in a reactor equipped with a stirrer, an inert gas (e.g., nitrogen) inlet, a thermocouple, a distillation column connected to a water-cooled condenser, a water separator, and a vacuum connection tube. For example, the equipment and procedures disclosed in U.S. Pat. Nos. 4,093,603 and 5,681,918, incorporated by reference herein, may be adapted for implementing the present invention.

In any embodiment, polycondensation processes may include melt phase processes conducted with the introduction of an inert gas stream, such as nitrogen, to shift the equilibrium and advance to high molecular weight and/or vacuum melt phase polycondensation at temperatures above about 150° C. and pressures below about 130 Pa (1 mm Hg). The esterification conditions can generally include: 1) an esterification catalyst, preferably in an amount from about 0.05 to 1.5% by weight of the reactants; 2) optional stabilizers, such as, for example, phenolic antioxidants such as IRGANOX 1010 or phosphonite- and phosphite-type stabilizers such as tributylphosphite, preferably in an amount from 0 to 1% by weight of the reactants; and/or 3) a temperature which is gradually increased from about 130° C. in the initial reaction steps up to about 190 to 280° C. in the later steps, initially under normal pressure, then, when necessary, under reduced pressure at the end of each step, while maintaining these operating conditions until a copolyester with the desired properties is obtained. If desired, the degree of esterification may be monitored by measuring the amount of water formed and the properties of the copolyester, for example, viscosity, hydroxyl number, acid number, and so on.

In any embodiment, the polymerization reaction to produce the copolyesters may be carried out in the presence of one or more esterification catalysts as mentioned above. Suitable catalysts may also include those disclosed in U.S. Pat. Nos. 4,025,492; 4,136,089; 4,176,224; 4,238,593; and U.S. Pat. No. 4,208,527; which are hereby incorporated herein by reference. Suitable catalyst systems may include compounds of Ti, Ti/P, Mn/Ti/Co/P, Mn/Ti/P, Zn/Ti/Co/P, Zn/Al, Sb (e.g., Sb₂O₃), Sn (e.g., dibutyltin oxide, dibutyltin dilaurate, n-butyltin trioctoate), and so on. When cobalt is not used in the polycondensation, copolymerizable toners may be incorporated into the copolyesters to control the color of these copolyesters so that they are suitable for the intended applications where color may be an important property. In addition to the catalysts and toners, other additives, such as antioxidants, dyes, etc., may be used during the copolyesterification, or may be added after formation of the polymer.

In general, the copolyesters may include conventional additives including pigments, colorants, stabilizers, antioxidants, extrusion aids, reheat agents, slip agents, carbon black, flame retardants, and mixtures thereof. In any embodiment, the copolyester may be combined or blended with one or more modifiers, and/or blend polymers including polyamides; e.g., NYLON 6,6® (DuPont), poly(ether-imides), polyphenylene oxides, e.g., poly(2,6-dimethylphenylene oxide), poly(phenylene oxide)/polystyrene blends; e.g., NORYL® (SABIC Innovative Plastics), other polyesters, polyphenylene sulfides, polyphenylene sulfide/sulfones, poly(ester-carbonates), polycarbonates; e.g., LEXAN® (SABIC Innovative Plastics), polysulfones, polysulfone ethers, poly(ether-ketones), combinations thereof, and the like.

Any of the copolyesters and compositions described herein may be used in the preparation of molded products in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion. The molding processes are well known to those of ordinary skill in the art. The polyester compositions described above may also be used in the preparation of nonwoven fabrics and fibers. In any embodiment, a shaped article such as an extruded profile or an extruded or injection molded article can comprise one or more copolyesters according to one or more embodiments disclosed herein. Accordingly, in any embodiment, copolyesters according to the instant invention can generally be molded and extruded using conventional melt processing techniques to produce a shaped article. Such articles may be transparent. The shaped articles manufactured from the copolyesters disclosed herein generally exhibit improved properties as shown in the examples below.

Shaped articles comprising any embodiment of the polymers disclosed herein may generally be produced using thermoplastic processing procedures such as injection molding, calendaring, extrusion, blow molding, extrusion blow molding, rotational molding, and so on. The amorphous and/or semicrystalline copolyesters of the present invention preferably exhibit improved stability at various melt temperatures. In the conversion of the copolyesters into shaped articles, the moisture content of copolyesters, according to the present invention, may often be reduced to less than about 0.02% prior to melt processing.

### EXAMPLES

In the following examples, dimethyl 4,4′-biphenyldicarboxylate (4,4′BB) and dimethyl 3,4′-biphenyldicarboxylate (3,4′BB) were supplied by EXXONMOBIL. Dimethyl terephthalate (DMT) (≥99%) was purchased from Sigma-Aldrich. These diacid esters were dried under vacuum at 35° C. for at least 16 hours and stored in a desiccator before use.

1,4-Cyclohexanedimethanol (CHDM) with a 30:70 ratio of cis:trans isomers was purchased from SIGMA-ALDRICH (mixture of cis and trans, ≥99%) and used as received.

2,2-Dimethyl-1,3-propanediol (neopentylglycol or NPG, 99%) was obtained from a commercial source and used as received.

Titanium (IV) butoxide (97%) was purchased from SIGMA-ALDRICH, and 0.02-0.06 g/mL titanium solutions in anhydrous 1-butanol were prepared.

All solvents, nitrogen gas (Praxair, 99.999%), oxygen gas (Airgas, 100%), and other gases were obtained from commercial sources and used as received. Dichloroacetic acid (≥99%) was purchased from Acros Organics. All other solvents were obtained from Spectrum.

In the following examples, the CHDM/EG/NPG copolyester copolymers are named according to a shorthand notation, wherein the name indicates the relative molar proportions of the various comonomers present therein. In examples based on multiple diols, the mole percentages of the diols are indicated. The sum of the mol% of the diol comonomers is 100. For example, a 100 mol % 4,4′BB with 40% EG and 60% CHDM diol content is named as 4,4′BB-60-EG-40-CHDM.

In the following examples, the scale of the copolymer synthesis may be indicated, where relevant, by a suffix following the copolymer notation. For example, a copolymer produced on a 20-30 g scale may be followed by “(20-30 g)” and a copolymer produced on a 100-150 g scale by “(100-150 g).”

Compression molding of copolyesters: All polymers were melt pressed between two aluminum plates, layered with KAPTON® films using a PHI Q-230H manual hydraulic compression press. Aluminum shims were inserted to control the film thickness. REXCO PARTALL® power glossy liquid mold release agent was applied to the KAPTON® films to facilitate release of the polyesters. Samples were heated at 275° C. for 1 minute for amorphous polyesters or 3 minutes for semi-crystalline polyesters before the top stainless steel plate was added. The plates were then centered in the press and closed until there was no visible gap between plates. After two more minutes of heating at 275° C., four 30-second press-release-press cycles were completed with the first two presses utilizing 44.5 kN (5 tons) force and the last two presses utilizing 89 kN (10 tons) force. After the final press, the aluminum plates were immediately submersed in an ice water bath to quench cool the samples. Films were then isolated and dried in a vacuum oven at 40° C. overnight before further characterizations.

NMR analysis: ¹H NMR spectra were acquired on a BRUKER AVANCE II 500 MHz instrument with a minimum of 32 scans at 23° C. Samples were dissolved (ca. 50 mg/mL) in mixtures of TFA-d and CDCl₃ (approximately 5:95 v/v) and chemical shifts are measured with respect to internal tetramethylsilane (TMS). Quantitative ¹³C NMR confirmed that melt-phase polymerization produced completely random copolymers.

Viscosity analysis: Inherent viscosities (IV) were measured in 0.5% (g/dL) dichloroacetic acid solution at 25° C. by means of a CANNON TYPE B glass capillary viscometer, adapted from ASTM D4603. Inherent viscosity at 0.5 g/dL dichloroacetic acid solution was used to calculate intrinsic viscosity according to the method outlined by Ma et al., “Fiber Spinning, Structure, and Properties of Poly(ethylene terephthalate-co-4, 4′-bibenzoate) Copolyesters,” Macromolecules, 2002, 35, 5123-5130. Some examples of the copolyesters disclosed herein achieved high inherent viscosities in the range of 0.8-0.9 dL/g or more, which corresponds to viscosity-average molecular weight of 26,600-30,700 g/mol, based on the empirical Mark-Houwink equation in which k=1.7×10⁻⁴ and α=0.83.

Thermogravimetric analysis: Thermogravimetric analysis (TGA) of polymer samples (˜10 mg) were analyzed using TGA Q500 (TA Instruments, New Castle, Del.) at a heating rate of 10° C./min from 30° C. to 600° C. under nitrogen. All of the synthesized materials were thermally stable up to 360-400° C. or more.

Differential scanning calorimetry: Differential scanning calorimetry (DSC) was conducted using Q2000 (TA Instruments, New Castle, Del.), calibrated with indium and tin standards. A small piece of polymer film (5 mg) was analyzed in a TZERO™ pan under a nitrogen atmosphere with heating and cooling rates of 10° C./min. The sample was held at temperature for 3 min between heating and cooling scans. Glass transition temperatures were measured as the midpoint of the transition in the second heating ramp.

Tensile testing: Dogbone samples were injection molded for tensile testing on a BOY-XS injection molding machine, with mold temperature of 7° C. (45° F.); barrel temperatures: 275° C.-290° C.; holding pressure: 6.9 MPa (1000 psi); and cycle time: ˜60 sec and were used for measurements without additional conditioning. Tensile testing was conducted on an INSTRON 5500R with a crosshead motion rate of 10 mm/min and an initial grip separation of 25.4±2.0 mm, and on an MTS Model No. 4204 with a 1 kN load cell and a crosshead motion rate of 5 mm/min (before 5% strain) and 10 mm/min (after 5% strain) with an initial grip-to-grip separation of 25.4±2.0 mm. Tensile modulus was estimated by crosshead displacement, but would likely be lower possibly due to sample slippage, which artificially increased the measured strain. In ASTM D638, an extensometer is generally used in the initial portion of the test to determine strain. An Epsilon 3442 miniature extensometer was therefore attached to more accurately measure the tensile modulus.

Examples 1-3, synthesis of 4,4′BB-50-EG-50-CHDM copolyester (15 g scale). All polymers made with a mixture of CHDM and EG (examples 1-3) were synthesized following a similar procedure. Reactions were performed in a dry 100 mL round bottom flask equipped with an overhead stirrer, a distillation arm and a nitrogen inlet. CHDM (3.7 g, 0.5 mol eq.+5% excess), EG (2.3 g, 0.5 mol eq.+50% excess) and 4,4′BB (13.1 g, 1 mol eq.) were charged into the flask along with titanium butoxide solution (40 ppm Ti to the theoretical yield). Reactions were degassed with vacuum and purged with nitrogen three times to remove oxygen. The reaction flask was submerged in a metal bath and stirred at 190° C. for 1 h, then 210° C. for 1 h, then 220° C. for 1 h, all while continually purging with nitrogen and stirring at 250 rpm. The temperature was then increased to 310° C. and the reaction was stirred at 30-40 rpm under reduced pressure (0.1-0.3 mmHg) for another hour. The polymer was then removed from the flask, rinsed with DI water and vacuum dried overnight at 10-20° C. above the polymer glass transition temperature.

Examples 4-7, synthesis of 4,4′BB-50-NPG-50-CHDM copolyester (20 g scale). All polymers made with a mixture of CHDM and NPG (examples 4-7) were synthesized following a similar procedure. Reactions were performed in a dry 100 mL round bottom flask equipped with an overhead stirrer, a distillation arm and a nitrogen inlet. CHDM (4.5 g, 0.5 mol eq.+3% excess), NPG (6.3 g, 0.5 mol eq.+100% excess) and 4,4′-BB (16.4 g, 1 mol eq.) or 1 mol eq. 3,4′-BB were charged into the flask along with titanium butoxide solution (40 ppm Ti to the theoretical yield). Reactions were degassed with vacuum and purged with nitrogen three times to remove oxygen. The reaction flask was submerged in a metal bath and stirred at 200° C. for 2 h, then 220° C. for 2 h, then 280° C. for 1 h, all while continually purging with nitrogen and stirring at 250 rpm. The stirring rate was then reduced to 30-40 rpm and the reaction was stirred under reduced pressure (0.1-0.3 mmHg) for another hour. The polymer was then removed from the flask, rinsed with DI water and vacuum dried overnight at 10-20° C. above the polymer glass transition temperature.

Examples 8 and 9, synthesis of 3,4′BB-65-EG-35-CHDM (22 g scale). Reactions were conducted in a dry 100 mL round-bottomed flask equipped with an overhead stirrer, nitrogen inlet, and distillation apparatus. All monomers were introduced to the flask in the desired proportions, e.g., for synthesis of 3,4′-BB-35-CHDM-65-EG, the monomers were EG (4.08 g, 1.5 mol eq. of targeted 65% incorporation) at a 50% molar excess, CHDM (33:67 cis:trans) (3.74 g, 1.1 mol eq. of targeted 35% incorporation), and 3,4′BB (18.20 g, 1.0 mol eq.). Titanium tetraisopropoxide (40 ppm) was added to the flask and used to catalyze the reaction. Degassing with vacuum and purging with nitrogen three times allowed the reaction to proceed oxygen free. The flask was then submerged in a heated bath and the reaction allowed to proceed at 170° C. for 1 h, at 200° C. for 1 h, at 220° C. for 2 h, and at 275° C. for 1 h, all while under constant stirring at 75 rpm and nitrogen purge. Vacuum was then applied until a pressure of 13-27 Pa (0.1-0.2 mm Hg) was achieved, and the reaction stirred at 275° C. for 1 h. The viscosity of the polymerizing clear melt increased as the polymerization progressed over time. The flask was removed from the heated bath and cooled to room temperature. The resulting polymer was removed from the flask and used without further purification.

The copolyester compositions and the physical properties are shown in Table 1.

TABLE 1

| Exam- | | IV | T_{d, 5%} | T_{g} | Tₘ |
|---|---|---|---|---|---|
| ple | Composition | (dL/g) | (° C.) | (° C.) | (° C.) |
| 1 | 4,4′BB-60-EG-40-CHDM | 0.66 | | 94 | 278 |
| 2 | 4,4′BB-50-EG-50-CHDM | 0.97 | 407 | 99 | 272.4 |
| 3 | 4,4′BB-40-EG-60-CHDM | 0.61 | | 103 | 271 |
| 4 | 4,4′BB-53-NPG-47-CHDM | 0.8 | 413 | 129 | ND |
| 5 | 4,4′BB-54-NPG-46-CHDM | 0.97 | 413 | 129 | ND |
| 5A | 4,4′BB-NPG | 0.89 | 419 | 116 | ND |
| 5B | T-95-4,4′BB-EG | | | 124 | 350 |
| 6 | 3,4′BB-50-NPG-50-CHDM | 0.75 | 415 | 109 | ND |
| 7 | 3,4′BB-50-NPG-50-CHDM | 0.87 | 415 | 110 | ND |
| 7A | 3,4′BB-NPG | 0.79 | | 104 | ND |
| 7B | 3,4′BB-EG | | | 104 | ND |
| 8 | 3,4′BB-64-EG-36-CHDM | | | 107 | ND |
| 9 | 3,4′BB-60-CHDM-40-EG | | | 112 | ND |
| 10A | T-NPG | 0.93 | 401 | 77 | ND |
| 10B | T-EG¹ | | | 81 | 252 |

ND = Not detected; 1 Commercial PET 418 from Scientific Polymer Products, Inc.

Selected copolyester physical properties are shown in Table 2.

TABLE 2

| | | Yield | Tensile stress | Elongation | | | |
|---|---|---|---|---|---|---|---|
| | | stress | at break | to Break | Young's | IV | Film |
| Example | | (MPa) | (MPa) | (%) | modulus | (dL/g) | thickness |
| 5 | (4,4′BB-54-NPG-46-CHDM) | 59.6 ± 0.6 | 64.5 ± 4.4 | 142.1 ± 16.8 | 1782.5 ± 43.8 | 0.97 | 0.58 ± 0.02 |
| 6 | (3,4′BB-50-NPG-50-CHDM) | 62.5 ± 0.4 | 56.8 ± 1.1 | 114.3 ± 5.6 | 1887.2 ± 66.1 | 0.75 | 0.56 ± 0.02 |

Instron, 10 mm/min rate, initial grip-to-grip separation ~25 mm, 0.5-0.6 mm thick films.

As these data show, copolyesters according to embodiments of the present invention comprising a single diacid, 4,4′-BB or 3,4′-BB, with mixtures of diols including CHDM and NPG result in amorphous copolyesters or semicrystalline copolyesters having extraordinary property profiles including unexpectedly high Tg, excellent elongation to break, and the like, which result in improved melt processability.

In examples 5A, 5B, 7A, 7B, 10A, and 10B, it is seen that NPG has an unexpected influence on the morphology and Tg of the bibenzoate polyesters. As Example 5A shows, the 4,4′-BB-NPG homopolymer has amorphous morphology and lower Tg relative to the mixed diols of Examples 4 and 5. The ability of NPG to suppress crystallinity in 4,4′-BB polyesters as seen in Examples 4, 5, 5A, and 5B is unexpected in view of the difficulty of obtaining an amorphous 4,4′-BB homopolyester. Also unexpected is the effect of NPG on Tg in the bibenzoate polyesters, which is increased in the 4,4′-BB-NPG-CHDM copolyesters in Examples 3-5 relative to the EG-CHDM copolyesters of Examples 1-2, unchanged in the 3,4-BB polyesters, e.g., 3,4′-BB-EG (Example 7B) and 3,4′-BB-NPG (Example 7A) both have Tg of 104° C., and decreased in the 4,4′-BB-NPG polyester of Example 5A relative to T-95-4,4′-BB-EG (Example 5B Tg 124° C.) and the copolyesters of Examples 4-5.

Although only a few example embodiments have been described in detail above, those skilled in the art will readily appreciate that many modifications are possible in the example embodiments without materially departing from this invention. Accordingly, all such modifications are intended to be included within the scope of this invention as defined in the following claims. It is the express intention of the applicant not to invoke 35 U.S.C. § 112(f) for any limitations of any of the claims herein, except for those in which the claim expressly uses the words ‘means for’ together with an associated function and without any recitation of structure. The priority document is incorporated herein by reference.

1. A copolyester comprising:
a diol component comprising a combination of first and second diols selected from the group consisting of C₂-C₂₀ alkylene diols and C₃-C₂₀ alicyclic polyhydroxyl compounds; and
a diacid component comprising a diacid selected from 4,4′-biphenyl dicarboxylate and 3,4′-biphenyl dicarboxylate.

2. The copolyester of claim 1, wherein the diacid component consists essentially of 4,4′-biphenyl dicarboxylate or 3,4′-biphenyl dicarboxylate.

3. The copolyester of claim 1, wherein the diol component consists essentially of the first and second diols, and may optionally further comprise up to 5 mol % of other diol components, based on the total moles of the diol component in the copolyester.

4. The copolyester of claim 1, wherein the diol component is selected from:
(a) from about 10 to 90 mol % 1,4-cyclohexanedimethanol (CHDM), and from about 90 to 10 mol % neopentyl glycol (NPG), preferably from about 25 to 75 mol % CHDM, and from about 75 to 25 mol % NPG; or from about 30 to 70 mol % CHDM, and from about 70 to 30 mol % NPG; or from about 35 to 65 mol % CHDM, and from about 65 to 35 mol % NPG; or from about 40 to 60 mol % CHDM, and from about 60 to 40 mol % NPG, based on the total moles of the diol component in the copolyester; or
(b) from about 10 to 90 mol % of the first diol comprising CHDM, and from about 90 to 10 mol % of the second diol selected from C₂ to C₂₀ alkylene diols, preferably ethylene glycol, 1,3-propanediol, 1,4-butanediol, 1,6-hexanediol, NPG, or a combination thereof, based on the total moles of the diol component in the copolyester; or
(c) from about 10 to 90 mol % of the first diol comprising NPG, and from about 90 to 10 mol % of the second diol selected from another C₂ to C₂₀ alkylene diol or an alicyclic polyhydroxyl compound, preferably ethylene glycol, 1,3-propanediol, 1,4-butanediol, 1,6-hexanediol, CHDM, or a combination thereof, based on the total moles of the diol component in the copolyester; or
(d) from about 10 to 90 mol % CHDM, and from about 90 to 10 mol % ethylene glycol, NPG, or a combination thereof, based on the total moles of the diol component in the copolyester; or
(e) from about 10 to 90 mol % CHDM, and from about 90 to 10 mol % ethylene glycol, preferably from about 25 to 75 mol % CHDM, and from about 75 to 25 mol % ethylene glycol; or from about 30 to 70 mol % CHDM, and from about 70 to 30 mol % ethylene glycol; or from about 35 to 65 mol % CHDM, and from about 65 to 35 mol % ethylene glycol; or from about 40 to 60 mol % CHDM, and from about 60 to 40 mol % ethylene glycol, based on the total moles of the diol component in the copolyester; or
(f) from about 10 to 90 mol % NPG, and from about 90 to 10 mol % ethylene glycol, preferably from about 25 to 75 mol % NPG, and from about 75 to 25 mol % ethylene glycol; or from about 30 to 70 mol % NPG, and from about 70 to 30 mol % ethylene glycol; or from about 35 to 65 mol % NPG, and from about 65 to 35 mol % ethylene glycol; or from about 40 to 60 mol% NPG, and from about 60 to 40 mol % ethylene glycol, based on the total moles of the diol component in the copolyester.

5. The copolyester of claim 1, wherein the diacid consists essentially of 4,4′-biphenyl dicarboxylate, or consists essentially of 3,4′-biphenyl dicarboxylate.

6. The copolyester of claim 1, wherein the diacid component further comprises up to 5 mol % of a second diacid, based on the total moles of the diacid component in the copolyester, preferably wherein the second diacid comprises terephthalate, isophthalate, or a combination thereof.

7. The copolyester of claim 1, further comprising an inherent viscosity equal to or greater than about 0.5 dL/g.

8. The copolyester of claim 1, wherein the copolyester has a glass transition temperature equal to or greater than about 90° C., or equal to or greater than about 95° C., or equal to or greater than about 100° C., or equal to or greater than about 105° C., or equal to or greater than about 110° C., or equal to or greater than about 115° C., or equal to or greater than about 120° C., or equal to or greater than about 125° C.

9. The copolyester of claim 1, exhibiting a zero shear melt viscosity less than 1700 Pa·s, or less than 1500 Pa·s, or less than 1300 Pa·s, or less than 1100 Pa·s, determined according to ASTM D3835 at 275° C.

10. The copolyester of claim 1, having an essentially amorphous morphology.

11. The copolyester of claim 1, having a semi-crystalline morphology, preferably having a melting point of less than about 280° C.

12. The copolyester of claim 1 comprising poly(4,4′-biphenyl dicarboxylate-(NPG-co-CHDM)), or poly(3,4′-biphenyl dicarboxylate-(NPG-co-CHDM)), or poly(4,4′-biphenyl dicarboxylate-(ethylene glycol-co-CHDM)), or poly(3,4′-biphenyl dicarboxylate-(ethylene glycol-co-CHDM)).

13. The polyester of claim 28 comprising 4,4′-biphenyl dicarboxylate-NPG, or 3,4′-biphenyl dicarboxylate-NPG.

14. A shaped article comprising the polyester or copolyester of claim 1.

15. The shaped article of claim 14, wherein the polyester or copolyester is in the form of a fiber, a nonwoven fabric, a film, or a molded article.

16. A method, comprising:
contacting (i) a diol component comprising a combination of first and second diols selected from the group consisting of C₂-C₂₀ alkylene diols and C₃-C₂₀ alicyclic polyhydroxyl compounds;
with (ii) a diacid component comprising a diacid selected from 4,4′-biphenyl dicarboxylic acid (4,4′-BB), 3,4′-biphenyl dicarboxylic acid (3,4′-BB), and ester producing equivalents thereof, in the presence of (iii) a catalyst; and
forming a copolyester comprising the diol and diacid components.

17. The method of claim 16, wherein the diacid component consists essentially of 4,4′-BB, or consists essentially of 3,4′-BB.

18. The method of claim 16, wherein the diol component consists essentially of the first and second diols, and may optionally further comprise up to 5 mol % of other diols, based on the total moles of the diol component in the copolyester.

19. The method of claim 16, wherein the diol component is selected from:
(a) from about 10 to 90 mol % 1,4-cyclohexanedimethanol (CHDM), and from about 90 to 10 mol % neopentyl glycol (NPG), preferably from about 25 to 75 mol % CHDM, and from about 75 to 25 mol % NPG; or from about 30 to 70 mol % CHDM, and from about 70 to 30 mol % NPG; or from about 35 to 65 mol % CHDM, and from about 65 to 35 mol % NPG; or from about 40 to 60 mol % CHDM, and from about 60 to 40 mol % NPG, based on the total moles of the diol component in the copolyester; or
(b) from about 10 to 90 mol % of the first diol comprising CHDM, and from about 90 to 10 mol % of the second diol selected from C₂ to C₂₀ alkylene diols, preferably ethylene glycol, 1,3-propanediol, 1,4-butanediol, 1,6-hexanediol, NPG, or a combination thereof, based on the total moles of the diol component in the copolyester; or
(c) from about 10 to 90 mol % of the first diol comprising NPG, and from about 90 to 10 mol % of the second diol selected from another C₂ to C₂₀ alkylene diol or an alicyclic polyhydroxyl compound, preferably ethylene glycol, 1,3-propanediol, 1,4-butanediol, 1,6-hexanediol, CHDM, or a combination thereof, based on the total moles of the diol component in the copolyester; or
(d) from about 10 to 90 mol % CHDM, and from about 90 to 10 mol % ethylene glycol, NPG, or a combination thereof, based on the total moles of the diol component in the copolyester; or
(e) from about 10 to 90 mol % CHDM, and from about 90 to 10 mol % ethylene glycol, preferably from about 25 to 75 mol % CHDM, and from about 75 to 25 mol % ethylene glycol; or from about 30 to 70 mol % CHDM, and from about 70 to 30 mol % ethylene glycol; or from about 35 to 65 mol % CHDM, and from about 65 to 35 mol % ethylene glycol; or from about 40 to 60 mol % CHDM, and from about 60 to 40 mol % ethylene glycol, based on the total moles of the diol component in the copolyester; or
(f) from about 10 to 90 mol % NPG, and from about 90 to 10 mol % ethylene glycol, preferably from about 25 to 75 mol % NPG, and from about 75 to 25 mol % ethylene glycol; or from about 30 to 70 mol % NPG, and from about 70 to 30 mol % ethylene glycol; or from about 35 to 65 mol % NPG, and from about 65 to 35 mol % ethylene glycol; or from about 40 to 60 mol% NPG, and from about 60 to 40 mol % ethylene glycol, based on the total moles of the diol component in the copolyester.

20. The method of claim 19, wherein the diacid consists essentially of 4,4′-BB, or consists essentially of 3,4′-BB.

21. The method of claim 16, wherein the diacid component further comprises up to 5 mol % of a second diacid or ester producing equivalent, preferably terephthalic acid, isophthalic acid, or an ester producing equivalent thereof, or a combination thereof, based on the total moles of the diacid component in the copolyester.

22. The method of claim 16, wherein the copolyester has an inherent viscosity equal to or greater than about 0.5 dL/g.

23. The method of claim 16, wherein the copolyester has a glass transition temperature equal to or greater than about 90° C., or equal to or greater than about 95° C., or equal to or greater than about 100° C., or equal to or greater than about 105° C., or equal to or greater than about 110° C., or equal to or greater than about 115° C., or equal to or greater than about 120° C., or equal to or greater than about 125° C.

24. The method of claim 16, wherein the copolyester exhibits a zero shear melt viscosity is less than 1700 Pa·s, or less than 1500 Pa·s, or less than 1300 Pa·s, or less than 1100 Pa·s, determined according to ASTM D3835 at 275° C.

25. The method of claim 16, wherein the copolyester has an essentially amorphous morphology.

26. The method of claim 16, wherein the copolyester has a semi-crystalline morphology, preferably having a melting point of less than about 280° C.

27. The method of claim 16, further comprising forming the copolyester into a shaped article, and/or into a fiber, a nonwoven fabric, a film, or a molded article.

28. A polyester comprising:
a diol component comprising, or preferably consisting essentially of or consisting of neopentyl glycol (NPG), and
a diacid component comprising a biphenyl dicarboxylate, preferably a diacid selected from 4,4′-biphenyl dicarboxylate and 3,4′-biphenyl dicarboxylate;
preferably wherein the polyester has an amorphous morphology.

29. A method comprising:
contacting (i) a diol component comprising, or preferably consisting essentially of or consisting of neopentyl glycol (NPG);
with (ii) a diacid component comprising a biphenyl dicarboxylate, preferably a diacid selected from 4,4′-biphenyl dicarboxylate and 3,4′-biphenyl dicarboxylate; and
forming a polyester comprising the diol and diacid components, preferably wherein the polyester has an amorphous morphology.

30. The method of claim 29, further comprising forming the polyester into a shaped article, and/or into a fiber, a nonwoven fabric, a film, or a molded article.
